(19) United States
(12) Patent Application Publication
(10) Pub. No.: US 2002/0093821 A1
(43) Pub. Date: Jul. 18, 2002

(54) Curtain-type hanging ring for christmas light bulb strings

(76) Inventor: Hung-Wen Lee, Hsinchu Shien (TW)

Correspondence Address: ROSENBERG, KLEIN & LEE, SUITE 101, 3458 ELLICOTT CENTER DRIVE, ELLICOTT CITY, MD, 21043, US

(21) Appl. No.: 09/756,277

(22) Filed: Jan. 9, 2001

(51) Int. Cl. F21V 21/00

(52) U.S. Cl. 362/249

(57) ABSTRACT

The present invention relates to a curtain-type hanging ring for Christmas light bulb strings, which includes several connectors to engage with several hanging rings, which are formed with different arched configurations. The connectors are capable of being hooked on any supporting objects to perform a curtain-type decoration, while the bulb sets are clipped on the rings to provide a utilized and novel decoration.

### BACKGROUND OF THE INVENTION

A known curtain-type light bulb string includes several separated hanging strings with the two ends connected on a supporting rod, which becomes an arc state for the basic decorative effect. This decorative state is not stable because the hanging strings will often be wound in accident and becomes chaos, which loses the purpose of decoration.

The primary object of the present invention is to provide a curtain-type hanging ring to support the Christmas light bulb string easily and firmly for obtaining a good decorative lighting effect. Now the features and advantages of the present invention will be described in detail with reference to the accompanying drawings.

### BRIEF DESCRIPTION OF ACCOMPANYING DRAWINGS

FIG. 1 is an exploded perspective view of a hanging ring with a light bulb string according to the present invention.

FIG. 2 is an assembled plan view of the curtain-type hanging ring with the Christmas light bulb strings according to the present invention.

FIG. 3 is a left side plan view of FIG. 2 according to the invention.

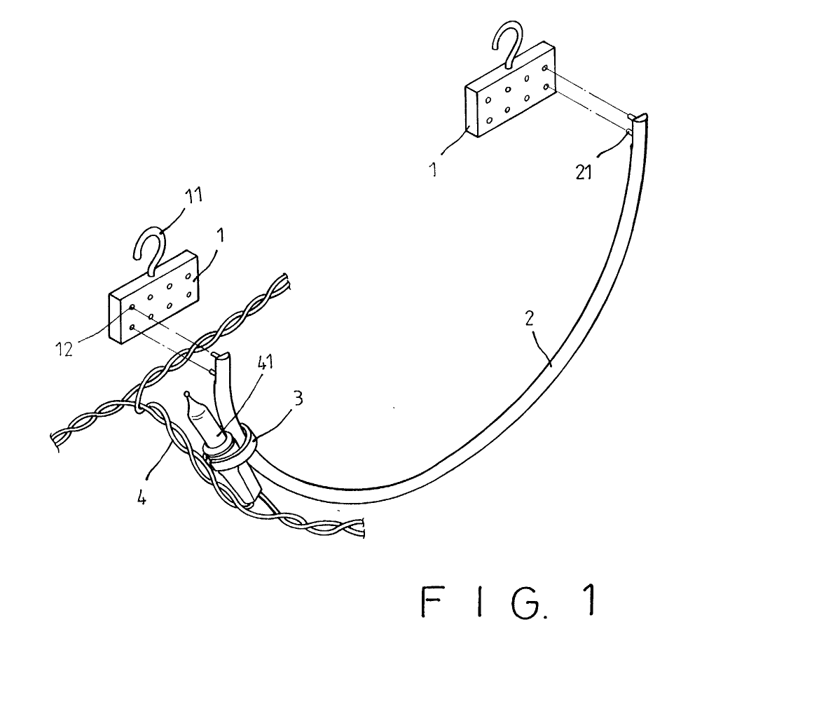

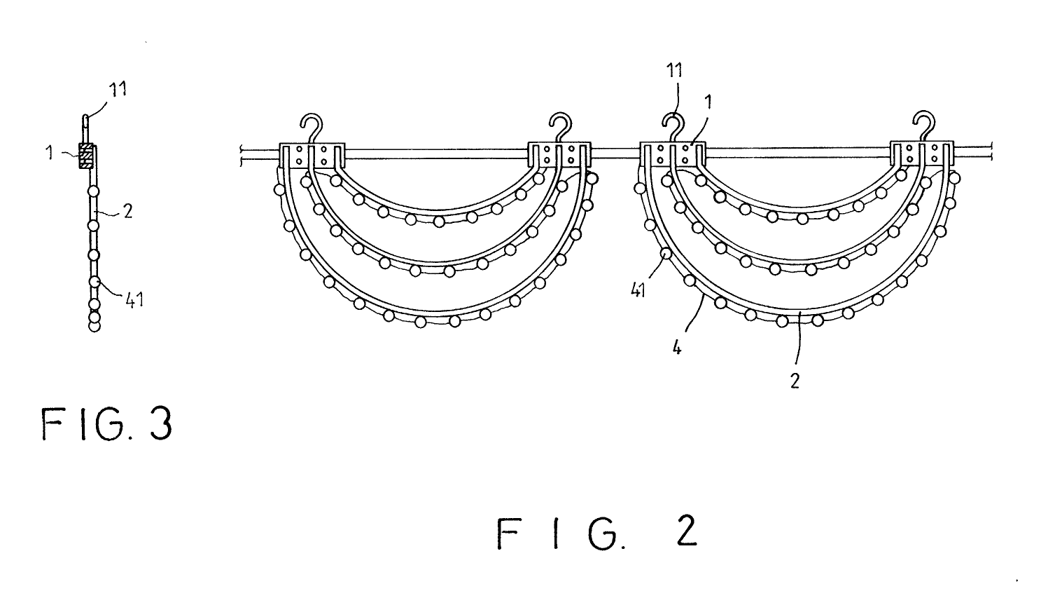

### DETAILED DESCRIPTION OF PREFERRED EMBODIMENTS

Referring to the appended figures of this invention, the present invention includes several connectors (1) having a top hook (11) thereon and several connecting holes (12) on the side face. Several hanging ring (2) having different arched configurations are provided and each arched ring (2) is provided with a pair of connecting beam (21) at both ends to engage with the connecting holes (12) on the connector (1). It can be seen that an assembly with several arched hanging rings is performed according to this invention. The Christmas light bulb strings (4) are capable of being appended on the hanging rings (2) by using an elastic clip (3) or the like to connect the bulb set (41) thereon for obtaining a stable decorative structure.

Accordingly, the light bulb strings (4) are easily connected with the arched hanging rings (2), wherein the strings (4) are never wound in accident. The stable curtain-type decorative effect will be maintained, while the hooks (11) are hooked on any supports in ease, that provides a beautiful decorative effect and overcomes the trouble of the prior art structure. Furthermore, it can be found that it is very convenient to assemble or to separate the hanging rings with the connectors and this is an improvement. Evidently the invention has the essence of a patent. We hereby apply for a patent grant.

What is claimed is:

1. A curtain-type hanging ring for Christmas light bulb strings including several connectors and several hanging ring having various arched configuration, wherein each connector having a top hook and several connecting holes on the face, and a pair of connecting beams being provided on both ends of each hanging ring to engage with the related connecting holes of two nearby connectors, that becomes a curtain-type decoration with different arched rings thereon for the Christmas light bulb strings appended.

2. The curtain-type hanging ring for Christmas light bulb strings as claimed in claim 1, wherein the bulb sets of the Christmas light bulb strings are engaged with the hanging ring by an elastic clip.

3. The curtain-type hanging ring for Christmas light bulb strings as claimed in claim 1, wherein the bulb sets of the Christmas light bulb strings are engaged with the hanging ring by any other connector being similar to the elastic clip.
